(19) United States
(12) Patent Application Publication
(10) Pub. No.: US 2016/0139250 A1
(43) Pub. Date: May 19, 2016

(54) SURROUNDINGS-SENSING DEVICE HAVING A MODULAR ULTRASONIC TRANSDUCER, AND MOTOR VEHICLE HAVING SUCH A SURROUNDINGS-SENSING DEVICE

(71) Applicant: ROBERT BOSCH GMBH, Stuttgart (DE)

(72) Inventors: Thomas Treptow, Leonberg (DE); David Bartylla, Leonberg (DE)

(21) Appl. No.: 14/899,800

(22) PCT Filed: May 26, 2014
(86) PCT No.: PCT/EP2014/060771

§ 371 Date: Dec. 18, 2015

(30) Foreign Application Priority Data
Jun. 20, 2013 (DE) 10 2013 211 593.8

(51) Int. Cl. G01S 7/521; G01S 15/93; B06B 1/06

(52) U.S. Cl. CPC G01S 7/521; B06B 1/06; G01S 15/931

(57) ABSTRACT

A surroundings-sensing device for emitting and/or receiving ultrasonic signals including an ultrasonic transducer, which includes at least one transducer element and at least one resonance body including a front body and a rear body, and including a diaphragm for sound transmission, which is coupled to an end face of the front body, the front body, the transducer element, and the rear body being separably connected to one another, and the front body being fastened on the diaphragm. Further described is a motor vehicle including a bumper, a side mirror, or a door section and at least one such surroundings-sensing device, the diaphragm of the surroundings-sensing device being formed by an outer skin of the bumper, the side mirror, or the door section and the ultrasonic transducer being situated concealed behind the outer skin.

### FIELD OF THE INVENTION

The present invention relates to a surroundings-sensing device for ultrasonic-based surroundings sensing using an ultrasonic transducer, as is used, inter alia, in conjunction with motor vehicles and also moving or stationary machines (for example, robots, agricultural machines, or construction machines), thus, for example, as a classic application, as a surroundings-detection aid for a corresponding parking assistance system, inter alia, for measuring distances to specific objects. The present invention additionally relates to a motor vehicle, in which at least one such surroundings-sensing device is situated on a bumper, a side mirror, or a door section of the motor vehicle.

### BACKGROUND INFORMATION

In recent time, ultrasonic-based surroundings sensors, in which piezo-based ultrasonic transducers are frequently used, have generally been used in motor vehicles in this technical field. Ultrasonic signals are typically transmitted through a medium such as air or water from an emitter to a receiver or transmitted from an emitter into the surroundings, or ultrasonic signals reflected from an object located in the surroundings are detected and the runtime and/or runtime differences and/or further variables, for example, amplitude and phases of the ultrasonic signals, are measured. To achieve sufficient transmission strengths and high reception sensitivities, these ultrasonic transducers are predominantly resonant oscillators, which include solid bodies and one or multiple piezoelements. Inter alia, piezo-based ultrasonic transducers, which are referred to as thickness oscillators, are known in the related art as a general example of such a resonant oscillator. A schematic construction of a known surroundings-sensing device is shown in FIG. 3, thickness oscillator 91 of surroundings-sensing device 9 being situated on a resonance surface 92 and having a planar piezoelement 912 as an ultrasonic transducer element, which is embedded in a resonance body, i.e., is situated between a front body 911 of the resonance body and a rear body 913 of the resonance body and is permanently connected thereto, typically by an adhesive bond or the like. Furthermore, front body 911 is also permanently connected to the inside of resonance surface 92, typically by an adhesive bond.

For visual reasons, the surroundings sensors are constructed ever smaller and installed ever more concealed, thus, for example, in a bumper of a motor vehicle, so that only the sensor front is still visible from a certain overall size. A specific example of an ultrasonic sensor for a motor vehicle may be inferred from DE 10 2007 046 031 A1. The ultrasonic sensor described therein is formed with an acoustic tuning layer, which is coupled to an oscillation element. The oscillation element generates ultrasonic waves, which are emitted into the surroundings of the motor vehicle, and the acoustic tuning layer is deformed by reflected ultrasonic waves, so that the piezoelectric oscillation element is set into resonance by the deformation. The ultrasonic sensor is glued in a hole in the bumper here, a receiving surface of the ultrasonic transducer being exposed toward the surroundings of the motor vehicle.

In the course of a further visual improvement of the known ultrasonic sensors, they are to be attached behind the bumper in the meantime, so that they are no longer optically visible. As an example of such a construction, it may be assumed for comparison in FIG. 3 that resonance surface 92 represents an outer skin of the bumper, thickness oscillator 91 being glued to the inside of outer skin 92. A disadvantage of this type of the ultrasonic transducers already known from the related art is, however, inter alia, that they cannot be removed nondestructively as a result of the permanent connection thereof to the bumper or to the corresponding resonance surface, so that defective sensors cannot be replaced without excessive effort.

### SUMMARY OF THE INVENTION

A surroundings-sensing device according to the present invention, which offers an answer to the above-discussed problems, includes at least one ultrasonic transducer and a diaphragm for sound transmission. The ultrasonic transducer includes at least one transducer element and at least one resonance body including a front body and a rear body. The diaphragm is coupled to an end face of the front body, the front body, the transducer element, and the rear body being separably connected to one another, and the front body being fastened on the diaphragm. Fastening of the front body on the diaphragm may be carried out by adhesive bonding, welding, fusing, or clamping the front body on the diaphragm, more precisely on the inside of the diaphragm. The front body may have a continuous, rod-like form, or it may also alternatively be configured in such a way that it has a plate shape on the end face of the front body connected to the diaphragm, tapers conically, or is shaped arbitrarily. In principle, any geometry may be selected for the front body and the rear body or the resonance body, as well as the transducer element. The cross section of these components may correspond to a correspondingly selected geometric shape, thus, for example, a circular shape, an elliptical shape, an oval shape, in particular having different axial lengths for different directional characteristics in the horizontal and/or vertical direction, a rectangular shape, in particular a square shape or the shape of a rectangle having rounded corners, in particular having different dimensions for different directional characteristics in the horizontal and/or vertical direction, or a combination of the above-mentioned geometric shapes. The diameter of the components of the ultrasonic transducer may be selected arbitrarily, the diameter of the individual components, in particular the front body, the transducer element, and the rear body, which may be selected in relation to one another in such a way that the diameters may be of equal size, or in such a way that the front body may have a smaller diameter than the rear body.

The front body and/or the rear body of the resonance body, also called oscillation body, may be manufactured from different materials, thus, for example, from metal, ceramic, or plastic (for example, polymers), or a combination thereof. The acoustic wave emitted from the transducer element for the surroundings sensing may leave the surroundings-sensing system in the direction of the end face of the front body, also referred to as the front mass, rearward radiation being completely suppressed in the best case. For this purpose, the rear body, also referred to as the rear mass, is used for attenuating the oscillation in relation to the area in which no emission is desired.

The concept of the transducer element is to be interpreted broadly and includes, for example, electroacoustic transducers, which operate according to electrostatic, magnetostrictive, or piezoelectric effects or combinations of these effects. Within the scope of the present invention, the transducer element may be a piezoceramic, an electret, for example, polyvinylidene fluoride (PVDF), or a piezoelectret, for example, charged porous polypropylene or Teflon or fluoroethylene propylene (FEP). In particular, the transducer element may be a piezoelectric element and the surroundings-sensing device may be understood as a piezoelectric surroundings-sensing device or a piezo-based surroundings-sensing device. The electrodes of the transducer element—not described in greater detail here—are connected via wires or litz wires to corresponding electronics, for example.

The so-called diaphragm of the surroundings-sensing device is formed, for example, by an outer skin of a bumper, a side mirror, a trim strip, a headlight, a taillight, or a door section of a motor vehicle, the transducer element or the transducer elements and the resonance body or the resonance bodies being situated concealed behind this outer skin. The diaphragm is excited by the coupling to the front body and the shared resonant design. The diaphragm may be formed from a thin material layer, which is manufactured, for example, from a polymer material typical for the outer skin of a motor vehicle. The diaphragm may have a thickness between 1.5 mm and 4 mm, particularly less than 2.5 mm. If the thickness of the outer skin does not correspond to the above-described thicknesses, which are for acoustic transmission, it may be provided that the bumper of the motor vehicle is configured to be correspondingly thinner in the area in which the surroundings-sensing device is to be installed than at another point, i.e., it has a thickness taper at the point of the surroundings-sensing device. Such local thinning or tapers may be incorporated both by subsequent machining, for example, by milling, or already in the manufacturing process, for example, during the injection molding.

The coupling of the resonance body on the end face to the diaphragm may be carried out directly or indirectly, in any case, however, in such a way that the front body is permanently connected to the diaphragm and thus acoustic coupling is enabled to a sufficient extent, i.e., acoustic energy may be transmitted to a sufficient extent. The direct coupling may be brought about, for example, by a press fit, a force-fit, for example, by screwing in, or also by adhesive bonding, welding, etc. Indirect coupling only means that a further material layer is additionally provided between the resonance body and the diaphragm, for example, a liquid, for example, a gel or an oil, an adhesive, an adhesive tape, or other material. This further material layer may be provided in particular to optimize the acoustic coupling between the ultrasonic transducer and the diaphragm or to compensate for unevenness.

Advantageous refinements and improvements of the device specified in the description herein are possible by way of the features set forth in the further descriptions herein.

In one embodiment of the surroundings-sensing device according to the present invention, the front body is fastened by a mount on the diaphragm. The mount may be configured to be mechanically elastic, so as to influence oscillations of the front body as little as possible. The mount furthermore ensures that the entire front body, which may already be permanently connected, for example, glued to the diaphragm on an end face, is fixed on the diaphragm. Such an arrangement is advantageous for the reason that the front body typically is not subject to a defect during normal operation of the surroundings-sensing device, i.e., it may be used in principle over the entire service life of the surroundings-sensing device. Due to the separable construction of the ultrasonic transducer, i.e., as a result of the modular construction thereof, a replacement of the transducer element and/or the rear body and coupling elements or coupling members optionally provided in between in the event of a defect of one of these components is enabled, the front body being able to remain together with the mount on the diaphragm, i.e., without having to replace the entire surroundings-sensing device. This takes into consideration the circumstance that typically the transducer element is the component of the ultrasonic transducer which may be subject to a defect during the conventional use of the surroundings-sensing device.

In one possible embodiment, the mount may be formed integrally with the front body, for example, by projections which protrude away from the front body and are capable of fixing the front body with the diaphragm. Alternatively thereto, the mount may be a separate component, the front body being permanently connected to the mount, in particular in that the front body is glued or pressed into the mount, i.e., into an opening in the mount. Further methods for the permanent connection of the mount to the front body are also conceivable, for example, an additional fixing device on the mount, for example, in the form of a holding clamp or holding spring. Depending on the material, welding of the mount to the front body would also be conceivable. To keep an influence on the oscillations of the front body as small as possible, on the one hand, the mount may be attached at an oscillation node (λ/4) and, on the other hand, the mount may furthermore be elastically supported with respect to the diaphragm by a bearing component, for example, by an elastic bearing ring or the like, which may be situated between the mount and the diaphragm or between the mount and a frame provided on the diaphragm.

Since, if a piezoceramic transducer element is used, the piezoceramic may only bear minor tensile stresses; in another embodiment of the surroundings-sensing device according to the present invention, the transducer element and the rear body are situated pre-tensioned against the front body. This pre-tensioning may be implemented in such a way that at least the transducer element and the rear body are situated pre-tensioned under pressure against the front body by way of at least one tensioning element. Such a tensioning element may be a screw or a tensioning disk, using which the rear body and the transducer element are pre-tensioned against the front body, optionally via the coupling members, which may be situated between these components, to optimally transmit the oscillations of the ultrasonic transducer between the components and optionally to compensate for unevenness. Alternatively to a screw connection by way of a tensioning screw or tensioning by a tensioning disk, other tensioning methods are also conceivable, for example, pre-tensioning with the aid of a spring disk or the like. Such a design of the ultrasonic transducer is used in particular in power ultrasonics, since high mechanical stresses may act there on the piezoceramic transducer element. However, since tensile stresses in particular may result in damage to the piezoceramic, the arrangement is pre-tensioned under pressure, so that the ultrasonic transducer may be stressed more strongly, without a fracture of the piezoceramic being caused.

The above-mentioned coupling members may be situated between the front body and the transducer element and/or the transducer element and the rear body, such coupling members may be made of a plastic, for example, an epoxy, a filled resin, or a polyethylene terephthalate (PET), a metal, for example, aluminum or brass, a gel, or of a combination thereof, and also of foamed materials, such as metals or plastics. Such a combination would be, for example, a coupling member which is constructed from a plastic disk or also a metal disk having gel, adhesive tape, or removable adhesive attached thereon.

For typical ultrasonic transducer applications, thickness oscillators are predominantly used, since the sound generation is sufficiently effective therein. These thickness oscillators generally include multiple elements, which are frequently manufactured from metal, ceramic, piezoceramic, or plastic. The mentioned materials share the feature that they do not have sufficient material attenuation for the application. Accordingly, it also may be that the surroundings-sensing device according to the present invention furthermore has an attenuation mechanism for attenuating the oscillation of the resonance body in the system, which is otherwise weakly attenuated. The sufficient attenuation of the mechanical resonance system is required to achieve adequate transient and sustained oscillation behavior for the surroundings sensing, to compensate for component tolerances, and to ensure the cooperation of multiple individual transducers. Thus, in one embodiment, the attenuation mechanism may be formed by a housing, in which an oscillation-attenuating material is embedded, which may be a silicone-based material, which encloses at least the transducer element and the rear body as much as permitted by the combination of mount and front body. A porous silicone foam may be used here, inter alia. The housing may be fastened on the diaphragm and may completely cover the ultrasonic transducer. Furthermore, the rear body may be provided with ribs or other protruding geometries, for example, nubs or wings or the like, so that in the event of an oscillation of the ultrasonic transducer and accordingly an oscillation of the resonance body, the attenuation material is compressed and the oscillation of the rear body is attenuated by the oscillation-attenuating material. Furthermore, the parts of the rear body provided with ribs or other protruding geometries may be embedded using the oscillation-attenuating material.

For example, a plastic or rubber material may be selected for the front body, the rear body being able to be manufactured, inter alia, from a metal, for example, from aluminum, sheet metal, steel, or brass. The selection of suitable materials may be defined by restrictions or specifications with respect to the reception sensitivities or transmission signal strengths of the surroundings-sensing device to be achieved. In particular, however, further ambient influences, for example, the ambient temperature or, for example, the mechanical stress by shaking, may be taken into consideration to define suitable materials. Furthermore, maximum installation depths may define the selection of the materials.

A resonance body manufactured in this way is particularly suitable for all vehicles or moving machines, which generally use a surroundings-sensing system. The present invention may be used in particular in such surroundings sensors which are provided, for example, in the front and/or rear bumper of a vehicle for the purposes of parking assistance and/or collision avoidance. Ultrasonic transducers are typically used, which may both emit ultrasonic waves and may also receive ultrasonic waves. However, it may also be provided that the ultrasonic transducers are only used as a receiver or only as an emitter. In particular, this is the case in the fields related to automotive technology of drive electronics and operating electronics, in the field of robotics, in particular for transportation robots in manufacturing, in hospitals, in nursing homes, in logistics fields, etc., and in the manufacturing of agricultural and construction machines.

Furthermore, according to the present invention, a motor vehicle having an outer skin and an above-described surroundings-sensing device is provided, the outer skin of the motor vehicle being formed by an outer skin of a bumper, a side mirror, a trim strip, a headlight, a taillight, a door section, or the like, and the ultrasonic transducer, i.e., the transducer element and the resonance body, being situated concealed behind the outer skin. In principle, the surroundings-sensing device according to the present invention may be situated at any point of the motor vehicle, at which sufficient installation space is present behind its outer skin. In particular, the surroundings-sensing device may be installed in an ultrasonic system, which includes a group of ultrasonic sensing devices, at least one, which may be all ultrasonic sensing devices including the above-described features of the surroundings-sensing device. The ultrasonic system may be configured, for example, to detect partial surroundings of the motor vehicle. For example, the ultrasonic sensing devices in the front area for detecting frontal vehicle surroundings and/or the ultrasonic sensing devices in the side area for detecting a side area of the vehicle and/or the ultrasonic sensing devices in the rear area for detecting rear surroundings of the vehicle may each be associated with such an ultrasonic system. In this case, four to six ultrasonic sensing devices are typically installed in a bumper, only at most four ultrasonic sensing devices being installed having approximately the same viewing direction. In particular to also detect the area adjacent to the vehicle, ultrasonic sensing devices are additionally positioned in the front bumper in such a way that they have their detection area to the left and right. Additionally or alternatively, ultrasonic sensing devices may also be positioned in the rear bumper in such a way that they acquire an area to the left and right adjacent to the motor vehicle. The ultrasonic system additionally also has a control unit associated with the particular group and a signal processing unit. To detect the lateral area of the vehicle, ultrasonic sensing devices installed laterally in the front and rear bumper may be used, and also those ultrasonic sensing devices which are installed in a side mirror or in a door section.

In motor vehicle surroundings-sensing devices according to the related art, ultrasonic transducer constructions are so far primarily believed to be understood, in which the ultrasonic transducer is completely permanently glued to a bumper or the like. A replacement of such an ultrasonic transducer if a defect occurs, for example, a defect of the piezoceramic transducer element, is therefore not possible without excessive effort, for example, residue-free cleaning of the adhesive points.

Using the present invention, it is possible in the event of such a defect of the ultrasonic transducer to only replace the defective components, without making it necessary to have to extricate the bumper from the entire ultrasonic transducer and attach a new ultrasonic transducer instead of the defective one. The parts to be replaced of the ultrasonic transducer may be offered as a replacement part, for example, in a combination made of transducer element, rear body, and housing, which, after removal of the defective surroundings-sensing device, may be easily replaced and easily pre-tensioned against the front body with the mount which is still present. In this way, trouble-free and cost-effective replacement of the defective parts of the surroundings-sensing device is possible.

Specific embodiments of the present invention are illustrated in the drawings and explained in greater detail in the following description.

### BRIEF DESCRIPTION OF THE DRAWINGS

FIG. 1 shows a longitudinal section of a schematic construction of a first specific embodiment of the surroundings-sensing device according to the present invention.

FIG. 2 shows a longitudinal section of a schematic construction of a second specific embodiment of the surroundings-sensing device according to the present invention.

FIG. 3 shows a longitudinal section of a schematic construction of an ultrasonic transducer according to the related art.

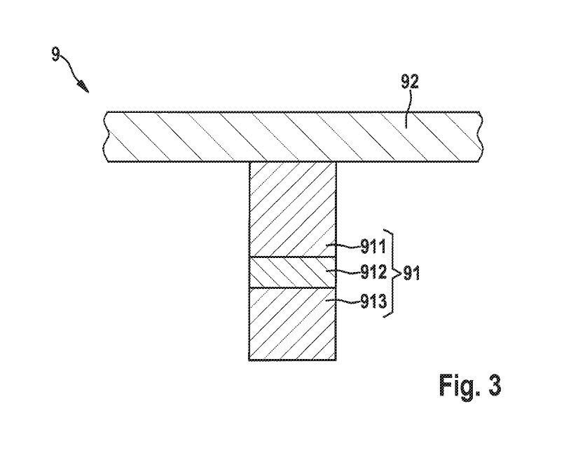

### DETAILED DESCRIPTION

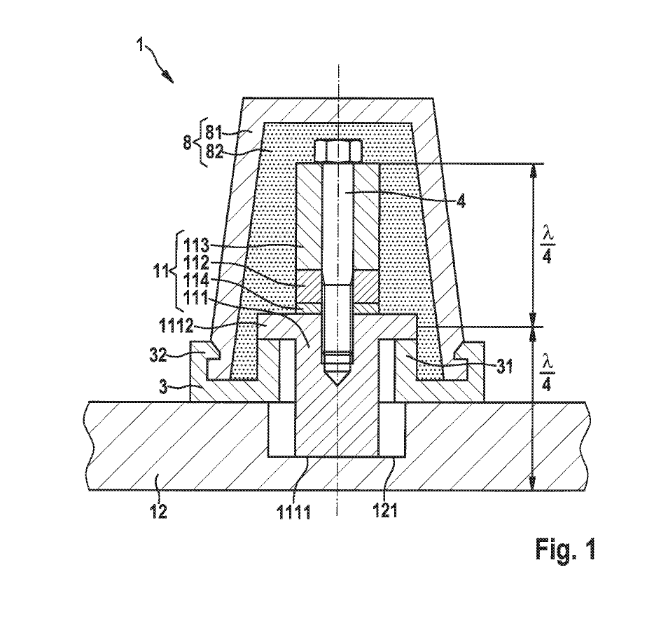

FIG. 1 shows a surroundings-sensing device 1 according to a first specific embodiment of the present invention in a lateral cross-sectional view. Surroundings-sensing device 1 includes an ultrasonic transducer 11 and a diaphragm 12, ultrasonic transducer 11 being constructed in principle from a combination of a front body 111, a piezoelectric transducer element 112, and a rear body 113, in this sequence. A coupling member 114 in the form of a plastic disk is situated between transducer element 112 and front body 111. Transducer element 112, rear body 113, and coupling member 114 are, in this specific embodiment, ring-shaped elements having a circular outside diameter and a circular opening in the middle. Contacting of piezoelectric transducer element 112 is carried out in this case by attaching a first pole on a first lateral surface of transducer element 112 and by attaching a second pole on the lateral surface opposite to the first lateral surface, the two poles being connected to the transducer element 112 by a soldered joint or the like. The two poles are connected to corresponding electronics of surroundings-sensing device 1. The contacts which are required for a function of piezoelectric transducer element 112 on each side of transducer element 112 are not shown in FIG. 1 for reasons of simplified illustration.

Transducer element 112, rear body 113, and coupling member 114 are pre-tensioned in this sequence by a tensioning screw 4, which extends through the particular central opening, against front body 111 and thereby fastened thereon in a modular construction. Front body 111 has a mount 1112 in the form of a disk-like projection, which extends outward from its end facing toward coupling member 114. Mount 1112 is fixed on a fastening disk 3 by adhesive bonding, welding, or the like, fastening disk 3 having a U shape in cross section and mount 1112 being fastened on one end 31 of the U shape.

Alternatively thereto, fastening disk 3 may also have an S shape in cross section, mount 1112 being fastened on one end of the S shape. A projection or a detent is provided on the other end 32 of the U shape, on which a housing 81 of an attenuation mechanism 8 is latched, the detent engaging with a groove on the outside of housing 81. Housing 81 is filled using an oscillation-attenuating silicone foam 82, which encloses transducer element 112, rear body 113, coupling member 114, the exposed end of tensioning screw 4, mount 1112 of front body 111, and end 31 of fastening disk 3. Silicone foam 82 may have already been introduced beforehand in the meaning of a negative mold into housing 81, but may also have only been injected subsequently into housing 81 after latching of housing 81, so that the mentioned components are completely extrusion coated. For the last mentioned purpose, housing 81 may have a filling opening (not shown) for injecting silicone foam 82.

Front body 111 is coupled to diaphragm 12 using an end face 1111, also called end section 1111 or end area 1111, which faces toward diaphragm 12. This means that in the illustrated specific embodiment, end face 1111 forms a contact surface to diaphragm 12. The coupling between front body 111 and diaphragm 12 takes place directly by adhesive bonding, welding, etc., between end face 1111 and diaphragm 12. Alternatively thereto, a mechanical coupling may be provided between end face 1111 and diaphragm 12, for example, by a screw connection or a clamping of front body 111 in diaphragm 12. Diaphragm 12 is configured to be thinner in this specific embodiment in a contact area between end face 1111 and diaphragm 12 than outside the contact area, so that front body 111 is at least partially countersunk in the contact area in an opening 121 in diaphragm 12. This has the advantage that surroundings-sensing device 1 may be configured to be sufficiently sensitive to receive ultrasonic waves or may emit sufficiently strong ultrasonic waves, on the one hand, and acoustic waves which are located in the horizontal direction in diaphragm 12 are partially reflected by an impedance jump and therefore interfere less, on the other hand. Furthermore, precise positioning of front body 111 during the installation and reduced installation depth of transducer element 112 may be achieved by this recess.

Entire ultrasonic transducer 11 has a rotationally symmetrical design in the first specific embodiment shown in FIG. 1, which means that the cross section of front body 111, the cross section of transducer element 112, the cross section of rear body 113, and also the cross section of coupling member 114 form a circular shape. In one embodiment, the diameter of front body 111 is smaller than the diameter of the remaining components. Alternatively thereto, the cross section of one of these components or all of these components may also have an elliptical shape, a rectangular shape, in particular a square shape or the shape of a rectangle having rounded corners, or a combination of the above-mentioned geometrical shapes.

Correspondingly, mount 1112 of front body 111 also has a circular shape, whereby mount 1112 assumes the shape of a disk in this specific embodiment. In one specific embodiment, mount 1112 is not provided circumferentially, but rather only partially, i.e., only at specific points on the outside circumference of front body 111. Weight and material of front body 111 may thus be saved and better decoupling may be achieved, since such a partially formed mount is more yielding in comparison to circumferential mount 1112. Opening 121 of diaphragm 12 corresponds to the cross-sectional shape of end face 1111 of front body 111. Resonance body 111, 113 is constructed in the first specific embodiment from a front body 111 made of a metal and/or polymer and from a rear body 113 made of metal and/or polymer.

As is furthermore shown in FIG. 1, ultrasonic transducer 11 of the first specific embodiment forms a λ/2 oscillator, in which front body 111 together with diaphragm 12 oscillates in resonance with a wavelength of λ/4, and in which the remaining construction, i.e., the combination of transducer element 112, rear body 113, and coupling member 114 also oscillates in resonance with a wavelength of λ/4. Mount 1112 is thus situated precisely in the center of the λ/2 oscillator, i.e., at λ/4, to ensure that mount 1112 is located in a nodal point of the oscillation, since the oscillation disappears in the nodal point and therefore mount 1112 does not influence the oscillation.

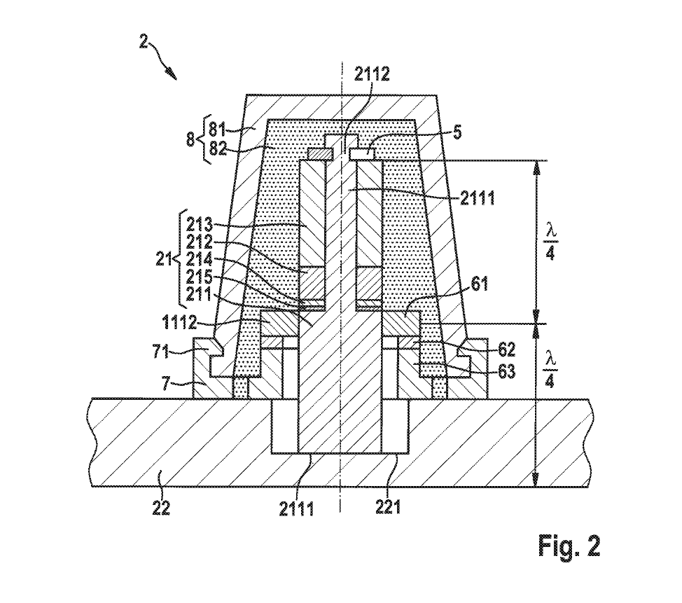

FIG. 2 shows a surroundings-sensing device 2 according to a second specific embodiment of the present invention in a lateral cross-sectional view. Surroundings-sensing device 2 includes an ultrasonic transducer 21 and a diaphragm 22, ultrasonic transducer 21 being constructed in principle from a combination of a front body 211, a piezoelectric transducer element 212, and a rear body 213, in this sequence. A coupling member 214 in the form of a plastic disk and, as part of coupling member 214, a coupling layer 215 optionally applied thereon, made of gel, an adhesive tape, or an easily removable adhesive, is situated between transducer element 212 and front body 211. Transducer element 212, rear body 213, and coupling member 214 are also ring-shaped elements having a circular outside diameter and a circular opening in the middle in this specific embodiment. Contacting of piezoelectric transducer element 212 is carried out in this case by attaching a first pole on a first lateral surface of transducer element 212 and by attaching a second pole on the lateral surface opposite to the first lateral surface, the two poles being connected by a soldered joint or the like to transducer element 212. The two poles are connected to corresponding electronics of surroundings-sensing device 2. The contacts which are required for a function of piezoelectric transducer element 212 on each side of transducer element 212 are not shown in FIG. 2 for reasons of simplified illustration.

Transducer element 212, rear body 213, and coupling member 214 are plugged in this sequence on a rod-shaped extension 2111 of front body 211, which extends through the particular central opening. A groove 2112 is provided on the exposed end of extension 2111, in which a tension ring 5 is situated, using which transducer element 212, rear body 213, and coupling member 214 are pre-tensioned against front body 111 and thereby fastened thereon in a modular construction. Front body 111 is pressed at the shoulder in front of extension 2111 into a separate mount 61 in the form of a ring-shaped disk. Mount 61 is fixed via a ring-shaped, elastic bearing washer 62 on a mounting bushing 63 by adhesive bonding, mounting bushing 63 having an L shape in cross section and mount 61 being fastened on the long end of the L shape. A catch bush 7 including a detent 71 is provided enclosing mounting bushing 63, on which a housing 81 of an attenuation mechanism 8 is latched, for which purpose detent 71 is engaged with a groove on the outside of housing 81. Housing 81 is filled, for example, using an oscillation-attenuating silicone foam 82 which, starting from the top, encloses the exposed end of front body 211, tension ring 5, transducer element 212, rear body 213, coupling member 214, coupling layer 215, mount 61, bearing washer 62, and mounting bushing 63. Silicone foam 82 may already have been introduced beforehand in the meaning of a negative mold into housing 81, but may also only have been injected subsequently into housing 81 after latching of housing 81, so that the mentioned components are extrusion coated. For the last mentioned purpose, housing 81 may have a filling opening (not shown) for injecting silicone foam 82.

Front body 211 is coupled to diaphragm 22 using an end face 2111 facing toward diaphragm 22, also called an end section 2111 or end area 2111. This means that in the illustrated specific embodiment, end face 2111 forms a contact surface to diaphragm 22. The coupling between front body 211 and diaphragm 22 takes place directly by adhesive bonding, welding, or the like between end face 2111 and diaphragm 22. Alternatively thereto, a mechanical coupling may be provided between end face 2111 and diaphragm 22, for example, by a screw connection or clamping of front body 211 in diaphragm 22. Diaphragm 22 is configured to be thinner in a contact area between end face 2111 and diaphragm 22 than outside the contact area in the second specific embodiment, similarly as in the first specific embodiment, so that front body 211 is at least partially countersunk in the contact area in an opening 221 in diaphragm 22. This has the advantage that surroundings-sensing device 2 may be configured to be sufficiently sensitive to be able to receive ultrasonic waves or to be able to emit sufficiently strong ultrasonic waves, on the one hand, and diaphragm 22 may be configured to be sufficiently thick outside the contact area, on the other hand.

Entire ultrasonic transducer 21 has a rotationally symmetrical design in this second specific embodiment, which means that the cross section of front body 211, the cross section of transducer element 212, the cross section of rear body 213, and also the cross section of coupling member 214 form a circular shape. Alternatively thereto, the cross section of one of these components or all of these components may also have an elliptical shape, a rectangular shape, in particular a square shape or the shape of a rectangle having rounded corners, or a combination of the above-mentioned geometric shapes. Accordingly, mount 61 also has a circular shape, whereby mount 61 assumes the shape of a disk in this specific embodiment. Opening 221 of diaphragm 22 corresponds to the cross-sectional shape of end face 2111 of front body 211. Resonance body 211, 213 is constructed in the second specific embodiment from a front body 211 and from a rear body 213 made of a glass-fiber-filled epoxy resin as the material.

Similarly to the first specific embodiment shown in FIG. 1, ultrasonic transducer 21 of the second specific embodiment forms a λ/2 oscillator, in which front body 211 oscillates together with diaphragm 22 in resonance with a wavelength of λ/4, and in which the remaining construction, i.e., the combination of transducer element 212, rear body 213, and coupling member 214, also oscillates in resonance with a wavelength of λ/4. Mount 1112 is thus situated precisely in the middle of the λ/2 oscillator, i.e., at λ/4, to ensure that mount 2112 is located in a nodal point of the oscillation, since the oscillation disappears in nodal points and therefore mount 2112 does not influence the oscillation.

The present invention is not restricted to the specific embodiments described here and the aspects emphasized therein. Rather, a variety of modifications are possible within the range specified by the claims, which are routine measures for those skilled in the art.

1-10. (canceled)

11. A surroundings-sensing device for emitting and/or receiving ultrasonic waves, comprising:
an ultrasonic transducer, which includes at least one transducer element and at least one resonance body having a front body and a rear body; and
a diaphragm for providing sound transmission, which is coupled to an end face of the front body;
wherein the front body, the transducer element, and the rear body are separably connected to one another, and
wherein the front body is fastened on the diaphragm.

12. The surroundings-sensing device of claim 11, wherein the front body is fastened on the diaphragm by a mount.

13. The surroundings-sensing device of claim 12, wherein the mount is integrally formed with the front body.

14. The surroundings-sensing device of claim 12, wherein the front body is permanently connected to the mount.

15. The surroundings-sensing device of claim 13, wherein the mount is elastically supported with respect to the diaphragm by a bearing component.

16. The surroundings-sensing device of claim 11, wherein the transducer element and the rear body are situated pre-tensioned against the front body.

17. The surroundings-sensing device of claim 16, wherein at least the transducer element and the rear body are situated pre-tensioned under pressure by at least one tensioning element against the front body.

18. The surroundings-sensing device of claim 11, further comprising:
an attenuation mechanism to attenuate the oscillation of the resonance body.

19. The surroundings-sensing device of claim 11, wherein a coupling member is situated between the front body and the transducer element and/or the transducer element and the rear body.

20. A motor vehicle, comprising:
an outer skin; and
at least one surroundings-sensing device for emitting and/or receiving ultrasonic waves, including:
an ultrasonic transducer, which includes at least one transducer element and at least one resonance body having a front body and a rear body; and
a diaphragm for providing sound transmission, which is coupled to an end face of the front body;
wherein the front body, the transducer element, and the rear body are separably connected to one another, and wherein the front body is fastened on the diaphragm;
wherein the diaphragm of the surroundings-sensing device is formed by the outer skin, wherein the outer skin of the motor vehicle includes one of the outer skin of a bumper, a side mirror, a trim strip, a headlight, a taillight, or a door section, and wherein the ultrasonic transducer is situated in a concealed manner behind the outer skin.

21. The surroundings-sensing device of claim 12, wherein the front body is permanently connected to the mount, in that the front body is glued or pressed into the mount.

22. The surroundings-sensing device of claim 16, wherein at least the transducer element and the rear body are situated pre-tensioned under pressure by at least one tensioning element against the front body, the tensioning element being a screw or a tensioning disk.

23. The surroundings-sensing device of claim 11, further comprising:
an attenuation mechanism to attenuate the oscillation of the resonance body, the attenuation mechanism being formed by a housing, in which an oscillation-attenuating material is embedded, which encloses at least the transducer element and the rear body.

24. The surroundings-sensing device of claim 11, wherein a coupling member is situated between the front body and the transducer element and/or the transducer element and the rear body, the coupling member being made of a plastic, a gel, a metal, an adhesive tape, or a combination thereof.
